(19) United States
(12) Patent Application Publication
(10) Pub. No.: US 2016/0083664 A1
(43) Pub. Date: Mar. 24, 2016

(54) Cavitation Generation Ring, Apparatus for Producing Carbon-Based Fuel, and Method for Producing Carbon-Based Fuel

(71) Applicant: ECO PRANA CO., LTD., Kanzaki-gun, Hyogo (JP)

(72) Inventor: Kaoru UNO, Hyogo (JP)

(21) Appl. No.: 14/785,288

(22) PCT Filed: Apr. 11, 2014
(86) PCT No.: PCT/JP2014/060496

§ 371 Date: Oct. 16, 2015

(30) Foreign Application Priority Data
Apr. 17, 2013 (JP) 2013-086307
Apr. 17, 2013 (JP) 2013-086633
Apr. 17, 2013 (JP) 2013-086997

(51) Int. Cl. C10L 1/02; B01J 19/24; B01J 19/00

(52) U.S. Cl. CPC C10L 1/02; B01J 19/008; B01J 19/245; C10L 2290/00; B01J 2219/24

(57) ABSTRACT

A cavitation generation ring configured to be housed in a part of a liquid communicating pipe, an apparatus for producing carbon-based fuel using the cavitation generation ring, and a production method of carbon-based fuel are disclosed. The production method comprises a petroleum decomposing step for decomposing a molecule of petroleum by cavitation, a water decomposing step for decomposing a molecule of water by cavitation, and a different-molecules composing step for composing the decomposed molecule of petroleum and the decomposed molecule of water by cavitation.

### TECHNICAL FIELD

The present invention relates to a cavitation generation ring, an apparatus for producing carbon-based fuel, and a method for producing the carbon-based fuel.

### BACKGROUND ART

Various methods for producing the carbon-based fuel have been proposed as a substitute for limited natural resource of petroleum.

For instance, in Fischer-Tropsch process synthesizing liquid hydrocarbon from carbon monoxide and hydrogen using catalysis to decompose the carbon-based fuel, the carbon monoxide and the hydrogen. i.e. starting materials, are generated by a method of steam reforming which gasifies hydrocarbon such as methane. The method of steam reforming utilizes heat reaction caused by high temperature steam.

Patent Literature 1 below discloses a method for producing the hydrocarbon including at least one of a liquefied petroleum gas component or a gas component, utilizing the reaction of the carbon monoxide and the hydrogen. In the method, the carbon monoxide and the hydrogen are mixed with fluid having a temperature equal to or higher than 230 degrees Celsius and pressure equal to or more than 0.1 MPa, the mixture is made to contact a catalyst, and the carbon monoxide and the hydrogen in the mixture react to produce the hydrocarbon.

Patent Literature 2 is cited as a method for producing a reaction product with an organic compound and water reacting. Patent Literature 2 discloses the method for producing the reaction product, i.e. synthetic petroleum, from a fluid mixture of the organic compound, such as glycidyl ether, and subcritical water from 100 degrees Celsius to 374 degrees Celsius in a liquid state, including 100 degrees Celsius and excluding 374 degrees Celsius.

In the method, the reaction product is produced where the temperature in a reaction field of the fluid mixture is in a range from 150 degrees Celsius to 374 degrees Celsius and the pressure in the reaction field is in a range from 0.1 Mpa to 30 Mpa.

### CITATION LIST

### Patent Literature

PTL 1: Japanese Patent Publication (unexamined) No. 2008-195773-A
PTL 2: Japanese Patent Publication (unexamined) No. 2007-176859-A

### SUMMARY OF INVENTION

### Technical Problem

However, on producing the carbon-based fuel, generating the high temperature steam is required in the above-mentioned Fischer-Tropsch process. The method described in Patent Literature 1 requires using high temperature liquid of at least equal to or higher than 230 degrees Celsius. In the method described in Patent Literature 2, the temperature in the reaction field is in the range from 150 degrees Celsius to 374 degrees Celsius, and at least the reaction field is required to keep a high temperature state.

Since each of the above-mentioned methods requires thermal energy to keep a high temperature, it is a problem to consume petroleum for producing the substitute for petroleum. To realize such heat treatment at the high temperature leads to consequent requirement of large-scale equipment, additional site, and time, without contribution to the reduction of carbon dioxide. Hence, from the standpoint of environmental and resource conservation, there are many discrepancies in the above-mentioned methods.

Not requiring the thermal energy, another method is also proposed for producing the carbon-based fuel with the starting material and an intermediate material decomposed and with these decomposed materials reacting.

In the above-mentioned case, physical decomposing is required to break the starting material and the intermediate material into pieces with the agitator such as a homogenizer and to agitate the materials with a line mixer or the like. Consequently, power for repeatedly breaking the starting material and the intermediate material into pieces with an agitator or the like is required.

Even in the case of adopting a batch process and performing agitation treatment repeatedly, there has been a problem that the precision of decomposing is not stable or decomposing so as to decompose a molecule is difficult to achieve.

The present invention is proposed in view of the above-mentioned problems. The present invention has an object to provide a cavitation generation ring, an apparatus for producing the carbon-based fuel, and a method for producing the carbon-based fuel, which perform decomposing of molecules of petroleum and water efficiently and with high precision and produce the carbon-based fuel from petroleum and water, by a simple method.

### Solution to Problem

In order to achieve the above-mentioned objects, a cavitation generation ring is configured to be housed in a pan of a liquid communicating pipe, and is characterized in that the cavitation generation ring has a plurality of protrusions protruding toward a center from an inner circumference of a cylindrical portion, the cylindrical portion constituting a liquid communication path of the liquid communication pipe, and liquid flows through the cavitation generation ring at high pressure and generates cavitation, thereby decomposing a molecule of the liquid.

In order to achieve the above-mentioned objects, an apparatus for producing carbon-based fuel comprises a petroleum decomposing device having the cavitation generation ring of the present invention and being configured to decompose a molecule of petroleum, a water decomposing device having the cavitation generation ring of the present invention and being configured to decompose a molecule of water, and a different-molecules composing device having the cavitation generation ring of the present invention and being configured so that a mixture of the molecule of petroleum decomposed by the petroleum decomposing device and the molecule of water decomposed by the water decomposing device flows through the cavitation generation ring at high pressure, and generates cavitation, thereby carbon-based fuel is produced by composing the decomposed molecule of petroleum and the decomposed molecule of water.

In addition, in order to achieve the above-mentioned objects, a production method of carbon-based fuel comprises a petroleum decomposing step for decomposing a molecule of petroleum, a water decomposing step for decomposing a molecule of water, and a different-molecules composing step for composing the decomposed molecule of petroleum and the decomposed molecule of water. In the petroleum decomposing step, a first cavitation generation ring is housed in a part of a petroleum communication pipe and petroleum flows through the first cavitation generation ring at high pressure and generates cavitation, thereby decomposing the molecule of petroleum. In the water decomposing step, a second cavitation generation ring is housed in a part of a water communication pipe and water flows through the second cavitation generation ring at high pressure and generates cavitation, thereby decomposing the molecule of water. In the different-molecules composing step, a third cavitation generation ring is housed in a part of a pipe where the mixture of the decomposed molecule of water decomposed in the water decomposing step and the decomposed molecule of petroleum decomposed in the petroleum decomposing step flows, and the mixture flows through the third cavitation generation ring at high pressure and generates cavitation, thereby carbon-based fuel is produced by composing the decomposed molecule of petroleum and the decomposed molecule of water. The first cavitation generation ring, the second cavitation generation ring and the third cavitation generation ring comprise the cavitation generation ring of the present invention.

In the production method of carbon-based fuel of the present invention, the method can comprise a step of mixing gas and liquid for containing a lot of gas bubbles in water by mixing gas in the water communicating pipe before the process in the first cavitation generation ring, and the water containing gas bubbles can flow at high pressure through the first cavitation generation ring and generate cavitation, thereby decomposing the molecule of water and decomposing the gas bubbles into nanosize.

In addition, in the present invention, in the different-molecules composing step, the method can be further include a stabilizing step in which a product generated by composing the decomposed molecule of petroleum and the decomposed molecule of water flows through a magnetic mixer and molecule composition of the product is stabilized.

### Advantageous Effects of Invention

In the present invention, the cavitation generation ring, the apparatus for producing the carbon-based fuel, and the method for producing the carbon-based fuel perform decomposing of the molecules of petroleum and water efficiently and with high precision by a simple method.

### BRIEF DESCRIPTION OF DRAWINGS

Both FIG. 1A and FIG. 1B are flow charts showing an example of the method for producing the carbon-based fuel in an embodiment of the present invention. FIG. 1A shows a first embodiment and FIG. 1B shows a second embodiment.

FIG. 2 shows an example of the cavitation generation ring for an embodiment of the present invention schematically. FIG. 2A is a schematic plan view. FIG. 2B is a schematic longitudinal sectional view taken in the direction of the arrows substantially along the line X-X in FIG. 2A.

FIG. 3 shows another example of the cavitation generation ring schematically. FIG. 3A is a schematic plan view. FIG. 3B is a schematic longitudinal sectional view taken in the direction of the arrows substantially along the line Y-Y in FIG. 3A.

FIG. 4A is a schematic view showing gas bubbles before cavitation treatment. FIG. 4B is a schematic view showing nano bubbles after cavitation treatment.

FIG. 5 is a schematic view showing an example of the apparatus for producing the carbon-based fuel in the first embodiment of the present invention.

FIG. 6 is a schematic view showing an example of the apparatus for producing the carbon-based fuel in the second embodiment of the present invention.

### DESCRIPTION OF EMBODIMENTS

An embodiment of the present invention is explained below with reference to the drawings.

As shown in FIG. 1A, a method for producing carbon-based fuel 1 in the first embodiment of the present invention is a method for producing carbon-based fuel 9 from petroleum 2 and water 4, and includes a petroleum decomposing step A decomposing a molecule of the petroleum 2, a water decomposing step B decomposing a molecule of the water 4, and a different-molecules composing step C composing molecules 2a and 4a each other which are decomposed in the above processes.

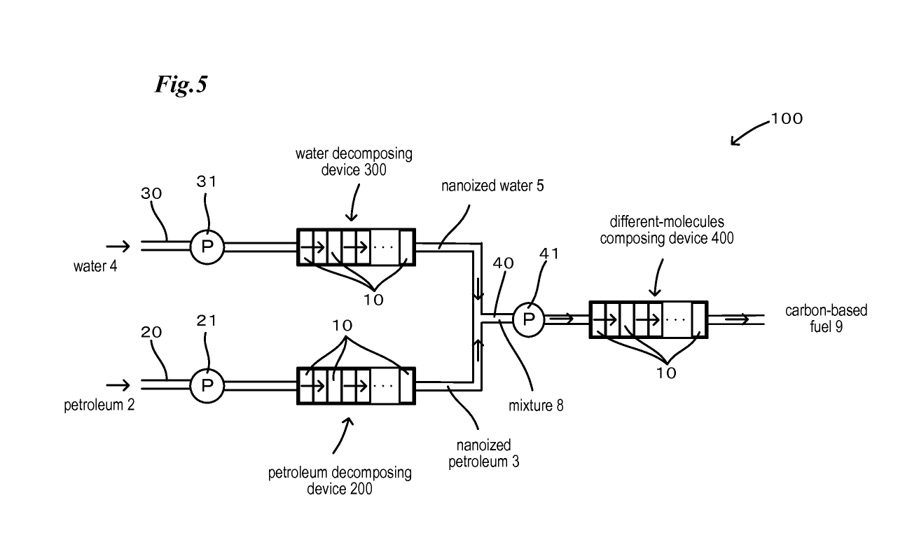

As shown in FIG. 5, the method for producing carbon-based fuel 1 is performed by an apparatus for producing carbon-based fuel 100 including petroleum decomposing device 200 with a cavitation generation ring (a ring 10), a water decomposing device 300 with the ring 10, and a different-molecules composing device 400 with the ring 10.

As shown in FIG. 5, in the petroleum decomposing step A, a first cavitation generation ring (a first ring) 10 is installed in a part of a pipe 20 where the petroleum 2 flows, and the petroleum 2 is caused to flow through the first ring 10 under high pressure. Thereby, cavitation is generated within the first ring 10 and the molecule of the petroleum 2 is decomposed.

In the embodiment, decomposing the molecule of the petroleum 2 is performed by the petroleum decomposing device 200 with a plurality of the first rings 10. Also, the petroleum 2 is caused to flow through the first ring 10 under high pressure by a pump 21 installed in a part of the pipe 20.

Processed in the petroleum decomposing step A, the molecule of the petroleum 2 is decomposed and the petroleum 2 becomes petroleum (nanoized petroleum) 3 containing a decomposed molecule of petroleum 2a.

Thus, when the petroleum 2 is processed in the petroleum decomposing step A, one or a plurality of carbon compositions in the molecule of the petroleum 2 is or are decomposed and the molecule of the petroleum 2 is separated into a plurality of pieces. Accordingly, carbon number contained in the decomposed molecule of petroleum 2a becomes smaller than that contained in the molecule of the petroleum 2 before decomposition.

As for the petroleum 2, various fuels can be used as long as the fuels are carbon-based fuels containing hydrocarbon as a main ingredient. For instance, gas oil and heavy oil in a range of 10C to 20C and gasoline in a range of 4C to 10C can be used. Fuels in various molecular structures such as a paraffin series, an olefinic system, a naphthene series, and an aromatic system can be used. As for the petroleum 2, the fuels of the paraffin series are desirable in terms of providing a high yield of the carbon-based fuel 9.

As shown in FIG. 5, in the water decomposing step B, a second cavitation generation ring (a second ring) 10 is installed in a part of a pipe 30 where the water 4 flows, and the water 4 is caused to flow through the second ring 10 under high pressure. Thereby, the cavitation is generated within the second ring 10 and the molecule of the water 4 is decomposed.

In the embodiment, decomposing the molecule of the water 4 is performed by the use of a water decomposing device 300 with a plurality of the second rings 10. Also, the water 4 is caused to flow through the second ring 10 under high pressure by a pump 31 installed in a part of the pipe 30.

Processed in the water decomposing step B, the molecule of the water 4 is decomposed and the water 4 becomes water (nanoized water) 5 containing a decomposed molecule of water 4a.

By the decomposition of the molecule of the water 4, a hydrogen atom or an oxygen atom are cut out from the molecule of the water 4 and the decomposed molecule of water 4a is generated. The molecule 4a can be constituted of only the hydrogen atom or the oxygen atom and can be in a state lacking a part of the hydrogen atom or the oxygen atom.

As for the water 4, various kinds of water can be used, such as tap water, natural water, e.g. well water, distilled water, ion exchanged water, water applied with reverse osmosis treatment, water applied with magnetic treatment and electrolysis etc., and water containing mineral components.

In the above, the word ‘nanoized’ is used like ‘nanoized petroleum 3 (water 5)’ wherein the word is used for convenience sake to express conceptually that the petroleum 3 (the water 5) contains the decomposed molecule 2a (4a).

As shown in FIG. 5, in the different-molecules composing step C, a third cavitation generation ring (a third ring) 10 is installed in a part of a pipe 40 where a mixture 8 of the molecule of the water 4a decomposed in the water decomposing step B and the molecule of the petroleum 2a decomposed in the petroleum decomposing step A flows, and the mixture 8 is caused to flow through the third ring 10 under high pressure. Thereby, cavitation is generated in the third ring 10 and the carbon-based fuel 9, i.e. the carbon-based fuel containing the hydrocarbon as a main ingredient, is produced by composing the decomposed molecules of petroleum 2a and water 4a.

The content of the water 4 (a volume percentage) used in the method for producing carbon based fuel 1, i.e. the water content in the mixture of the water 4 and the petroleum 2, can be, e.g., 30 percent to 50 percent.

A widely known additive can be appropriately added to any of the liquids (the petroleum 2, the water 4, and the mixture 8) before treatment in the above-mentioned steps A, B, and C.

Composing reaction between the decomposed molecules of petroleum 2a and water 4a is promoted by adding the additive as above.

The word ‘different-molecules’ is used as in ‘the different-molecules composing step C’, wherein the word is used for convenience sake to express conceptually that the step is to compose the molecules being different from each other, i.e. the decomposed molecules 2a, 4a.

In the embodiment, the decomposed molecules of petroleum 2a and water 4a are composed to produce the carbon-based fuel 9 using the different-molecules composing device 400 with a plurality of the third rings 10. The above-mentioned mixture 8 is caused to flow through the third ring 10 under high pressure by a pump 41 installed in a part of the pipe 40.

When the mixture 8 is processed in the different-molecules composing step C, the decomposed molecules of petroleum 2a and water 4a in the mixture 8 are composed and the carbon-based fuel 9 is produced. Specifically, a single or a plurality of the decomposed molecules of petroleum 2a, i.e. the molecule 2a of which the carbon number becomes smaller than the original molecule of the petroleum 2, and a single or a plurality of the decomposed molecules of water 4a, i.e. the molecule 4a constituted of only the hydrogen atom or the oxygen atom, or the molecule 4a lacking a part of the hydrogen atom or the oxygen atom, or the like, are composed by a covalent bond and the carbon-based fuel 9 is produced.

The percentage of the water content in the carbon-based fuel 9 produced as above is less than 1 percent. In the different-molecules composing step C, reaction heat is generated and the temperature becomes higher than that before the reaction by about 10 degrees Celsius at the time of the composing reaction between the decomposed molecules of petroleum 2a and water 4a.

Next, the ring 10 used in the method for producing carbon-based fuel 1 (the apparatus for producing carbon-based fuel 100) is explained.

The ring 10 is installed in a pan of the pipes 20, 30, 40 where the liquid, i.e. the petroleum 2, the water 4, and the mixture 8, flows.

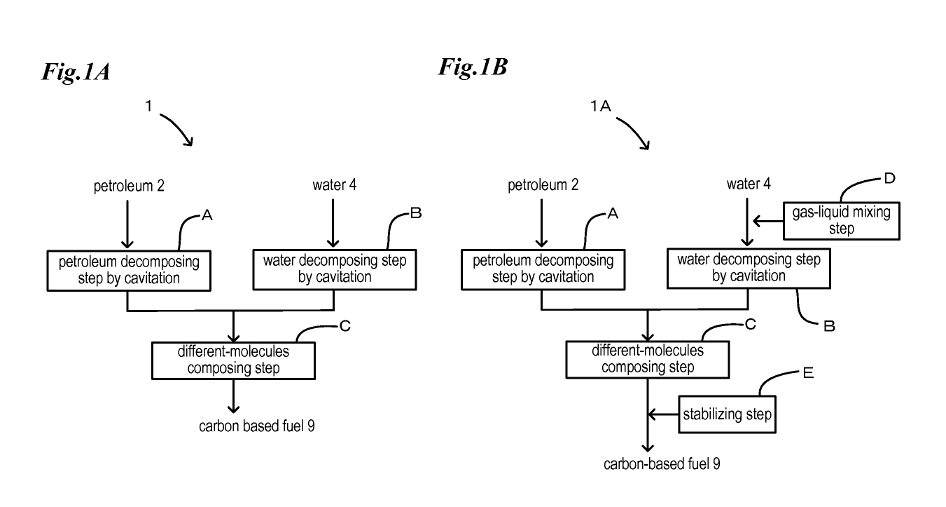

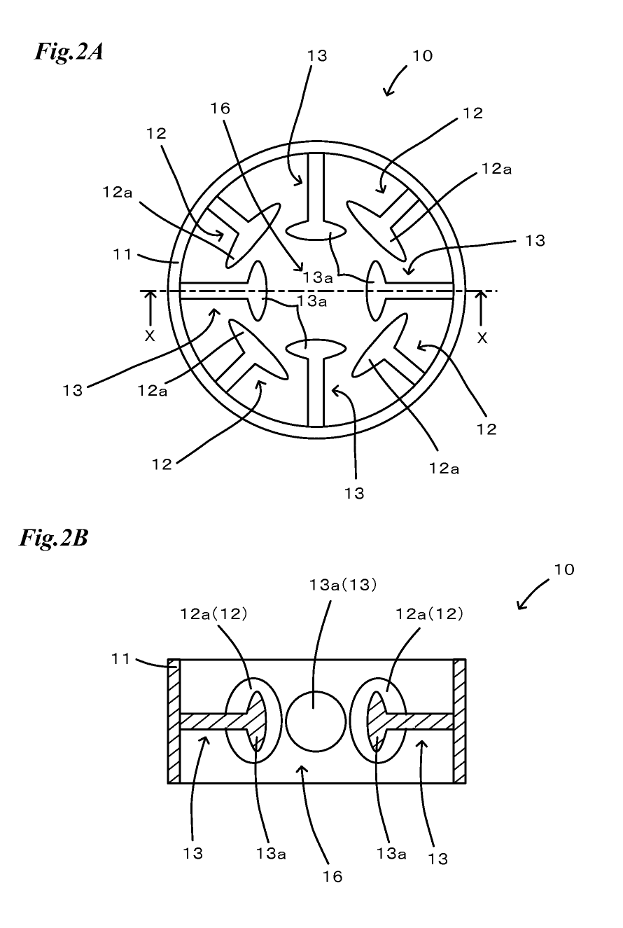

As shown in FIG. 2A and FIG. 2B, the ring 10 has a structure in which a plurality of protruding portions 12, 13 protrude toward a center from an inner circumferential face of a cylindrical portion 11 so as to form a flow passage 16 of the liquid, i.e. the petroleum 2, the water 4, and the mixture 8, inside of the cylindrical portion 11. The cavitation is generated inside of the cylindrical portion 11 by making the liquid flow through the cylindrical portion 11 under high pressure.

The pressure of the liquid flowing through the ring 10 can be about 1 Mpa to 10 Mpa and flow velocity of the liquid may be equal to or more than 150 meters per minute.

The pressure of the liquid and the flow velocity can be appropriately adjusted for generating the effective cavitation, for instance, according to the temperature, the viscosity, or the like of the liquid.

In the embodiment, as shown in FIG. 2A and FIG. 2B, the ring 10 has a plurality of protruding portions 12 (4 portions in the figure) having substantially the same dimension and shape and a plurality of protruding portions 13 (4 portions in the figure) having substantially the same dimension and shape. The protruding dimensions of the protruding portions 13 are larger than those of the protruding portions 12.

In the embodiment, a plurality of the protruding portions 12, 13 are respectively formed into mushroom shapes and head portions 12a, 13a in two or more different sizes are used in combination. In the figure, the shapes of the head portions 12a, 13a are formed substantially in disk shapes and the ring 10 having two kinds of the head portions 12a, 13a are illustrated.

The head portions 12a, 13a are in such a size that they do not interfere with each other's protruding portions 12, 13. The size of the head portions 12a, 13a is not limited to the size in the figure and three or four kinds of different size of the head portion can be used.

The inner diameter of the cylindrical portion 11 in the ring 10 can be, for instance, 10 mm to 50 mm. The width dimension of the cylindrical portion 11, i.e. the dimension along the flow direction of the liquid can be, for instance, 5 mm to 30 mm. The protruding dimension of the protruding portions 12, 13 is designed so that the protruding portions 12, 13 do not interfere with each other and can be, for instance, one tenth to one half of the inner diameter of the cylindrical portion 11.

The ring 10 can be made of oxide-based ceramic such as aluminum oxide or zirconia, made of metal such as stainless steel, or made of synthetic resin.

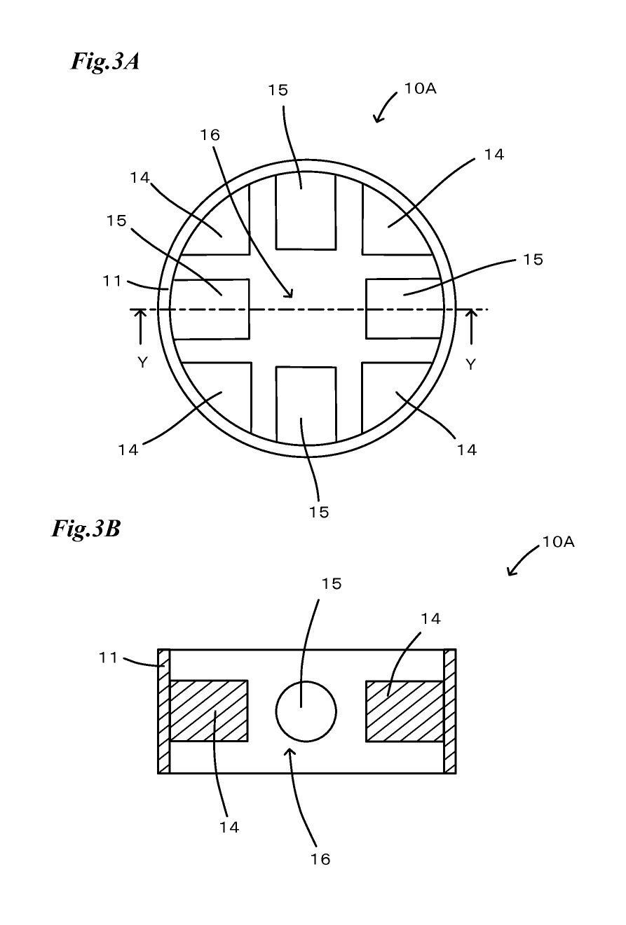

The ring 10 is not limited to ones having the protruding portions 12, 13 of the shapes shown in FIG. 2A and FIG. 2B and can be a ring 10A having protruding portions 14, 15 of the shapes shown in FIG. 3A and FIG. 3B.

FIG. 3A and FIG. 3B show the ring 10A having the protruding portion 14 of a mountain shape viewed in cross-section and the protruding portion 15 of a cylindrical shape.

The protruding portions are not limited to the shapes as mentioned above and can be of various shapes.

When the liquid (the petroleum 2 and the water 4) is caused to flow through the cylindrical portion 11 of the ring 10 composed as mentioned above under high pressure by the pumps 21, 31, the liquid collides with the protruding portions 12, 13 in the process of advancing in the flow passage 16 within the cylindrical portion 11 and the pressure of the liquid around a collided region decreases instantaneously.

When the pressure of the liquid becomes lower than saturated steam pressure for only a short time, the liquid vaporizes into minute gas bubbles equal to or less than 100 micrometers existing in the liquid, and the extrication of dissolved gas is generated. A lot of tiny gas bubbles, i.e. vacuum micro bubbles, are thereby generated.

Since the pressure of the liquid around the vacuum micro bubbles is higher than the saturated steam pressure, the surrounding liquid rushes to the center of the vacuum micro bubbles and collides with each other at the center at the moment when the vacuum micro bubbles disappear.

A strong pressure wave, i.e. an impulse wave, is thereby generated and the cavitation is generated within the cylindrical portion 11.

The strong impulse wave generated by the cavitation affects molecules of the liquid surrounding the periphery of the vacuum micro bubbles, the composing of atoms constituting the molecules is disconnected, and the molecules are decomposed. Namely, the nanoized petroleum 3 including the decomposed molecule of petroleum 2a and the nanoized water 5 including the decomposed molecule of water 4a are generated since the molecules of the liquid, i.e. the petroleum 2 and the water 4, are decomposed by the cavitation.

When the mixture 8 of the decomposed molecules of water 4a and petroleum 2a is caused to flow through the cylindrical portion 11 of the ring 10 composed as mentioned above under high pressure by the pump 41, the mixture 8 collides with the protruding portions 12, 13 in the process of advancing in the flow passage 16 within the cylindrical portion 11 and the pressure of the liquid around a collided region decreases instantaneously.

In the same manner as mentioned above, a lot of vacuum micro bubbles are thereby generated within the mixture 8, the strong pressure wave, i.e. the impulse wave, is generated at the moment when the micro bubbles disappear, and the cavitation is generated within the cylindrical portion 11.

The strong impulse wave generated by the cavitation affects the decomposed molecules of water 4a and petroleum 2a in the mixture 8 surrounding the periphery of the vacuum micro bubbles. The effects of the cavitation and colliding each other with the decomposed molecules 2a, 4a under high pressure are combined, the decomposed molecules 2a, 4a are composed by the covalent bond, and the carbon-based fuel 9 is produced. The carbon-based fuel 9 produced as above includes oxygen in addition to the hydrogen and the carbon as a constituent atom of the carbon-based fuel 9 as mentioned below.

As in the embodiment, the above-mentioned impulse wave is effectively generated and the effect of the cavitation is amplified when the ring 10 is constituted by the combination of more than two kinds of size of the head portions 12a, 13a.

Thereby, the molecules of the petroleum 2 and the water 4 are more effectively decomposed, and the decomposed molecules 2a, 4a are more effectively composed to produce the carbon-based fuel 9.

In the embodiment, as shown in FIG. 5, the petroleum decomposing device 200, the water decomposing device 300, and the different-molecules composing device 400 are constituted by connecting a plurality of the rings 10 being able to be mutually connected and decomposed. A plurality of the rings 10 are connected so that the insides of cylinders are communicated with each other and the above-mentioned devices 200, 300, 400 are constituted.

The above-mentioned constitution is able to increase or decrease cavitation generation quantity by increasing or decreasing appropriately the connecting number of the ring 10 constituting the devices 200, 300, 400. When the connecting number of the rings 10 increases, the cavitation generation quantity increases and the generation region of the above-mentioned impulse weave increases, thereby enhancing the degree of decomposing the molecules of the petroleum 2 and the water 4, and enhancing the degree of composing the decomposed molecules 2a, 4a. On the other hand, when the connecting number of the rings 10 decreases, the degree of decomposing the molecules of the petroleum 2 and the water 4 and the degree of composing the decomposed molecules 2a, 4a are lowered.

The degree of decomposing the molecules of the petroleum 2 and the water 4 and the degree of composing the decomposed molecules 2a, 4a are adjusted by adjusting the cavitation generation quantity as above. Although the degree of decomposing the molecules of the petroleum 2 and the water 4 and the degree of composing the decomposed molecules 2a, 4a vary sometimes due to the temperature, the viscosity, or the like of the petroleum 2, the water 4, and the mixture 8, the cavitation generation quantity is adjusted by increasing or decreasing appropriately the connecting number of the ring 10 for the optimum degrees of decomposing and composing.

As for the pumps 21, 31, 41, various constitutions can be used as long as the liquid, i.e. the petroleum 2, the water 4, or the mixture 8, flows under high pressure inside of the pipes 20, 30, 40. As for the pipes 21, 31, 41, a plunger pump, a gear pump, a cascade pump, or the like can be used, for instance.

As for the pipes 20, 30, 40, constitution being able to resist the flow of high pressure liquid, i.e. the petroleum 2, the water 4, and the mixture 8, can be used. For instance, constitution made of metal such as the stainless steel or copper or constitution made of synthetic resin such as polyvinyl chloride can be used. The diameter of the pipes 20, 30, 40 can be, for instance, 1 mm to 20 mm.

The result of analyzing the component of the carbon-based fuel 9 produced by the method for producing carbon-based fuel 1 (the apparatus for producing carbon-based fuel 100) is shown below:
Analysis Company: Nippon Steel & Sumikin Technology Co., Ltd.
The Date of Issue of Report: May 20, 2013
Purpose: To perform a GC/MS analysis (Gas Chromatography-Mass Spectrometry) with respect to the carbon-based fuel and to comprehend the component of the carbon-based fuel.
Sample: The carbon-based fuel produced on Mar. 4, 2013
The Method of Analysis:
(Sample Preparation) An analysis sample was prepared by producing the carbon-based fuel (the water content being 30 (volume percentage)) from the water and paraffin-based fuel, diluting approximately 0.1 gram of the carbon-based fuel with acetone, and fixing the volume at 10 milliliters.
(Analysis Instrument)
GC Instrument (Gas Chromatography Instrument): HP6890 (Made by HP, i.e. Hewlett-Packard Company)
Column=UA-5 28.5 meters×0.25 millimeters×0.25 micrometers, Temperature-Rising conditions=40 degrees Celsius (5 minutes)→10.0 degrees Celsius per minute→150 degrees Celsius→20.0 degrees Celsius per minute→320 degrees Celsius (5 minutes), Carrier Gas=Helium. Column Flow=1.2 milliliters per minute, Inlet Temperature=280 degrees Celsius, Split 20:1
MS Instrument (Mass Spectroscope): HP5973 (Made by HP)
Mass Range n/z=29.0 to 550.0 (Scan Measurement), Interface Temperature=320 degrees Celsius
The Result of Analysis: According to the result of mass spectrum search for a peak component in a chromatogram of the GC/MS analysis, a peak presumed to be a saturated hydrocarbon (C9H20 to C27H56) or a carboxylate ester (methyl palmitate, methyl oleate) was obviously detected from the liquid obtained by diluting the sample with the acetone.

Observation:

The carboxylate ester (the methyl palmitate, the methyl oleate) which did not exist before the processing is newly generated by the method for producing the carbon-based fuel 1. As for a generating mechanism of the carboxylate ester, the carboxylate ester is generated by composing the molecule of the petroleum 2 decomposed by the cavitation and the oxygen derived from the decomposed molecule of water 4a.

The result of CHN analysis in the carbon-based fuel 9 produced by the method for producing carbon-based fuel 1 (the apparatus for producing carbon-based fuel 100) is shown below:
Measurement Company: Nichiyu Techno Co., Ltd.
The Date of Issue of Report: Feb. 17, 2014
Measurement Sample: The carbon-based fuel produced by water and petroleum (the water content being 40) (volume percentage))
The Result of Measurement:

TABLE 1

| Measurement | Measurement Result | |
|---|---|---|
| Item | (percentage) | Measurement Method |
| Carbon | 75.1 | CHN Analyzer |
| | | (CHN: Carbon, Hydrogen, Nitrogen) |
| Hydrogen | 11.5 | CHN Analyzer |
| Oxygen | 12.6 | Calculation by the Measurement |
| | | Result of CHN Analyzer |

Observation:
It is shown that the carbon-based fuel includes oxygen atom in addition to the carbon atom and the hydrogen atom. It is suggested that the oxygen atom in the carbon-based fuel derives from the molecule of the water.

The method for producing carbon-based fuel 1 in the first embodiment, the apparatus for producing carbon-based fuel 100, and the cavitation generation ring (the ring) 10 constituted as above enable decomposing of the molecules of the petroleum and the water efficiently and with high precision, and production of the carbon-based fuel from the petroleum and the water by a simple method. Namely, the ring 10 decomposes the molecules of the liquid such as the petroleum 2 and the water 4 by the cavitation generated within the ring 10 while having a simple structure provided with the cylindrical portion 11 and the protruding portions 12, 13.

In the method for producing carbon-based fuel 1 and the apparatus for producing carbon-based fuel 100, the molecules of the petroleum 2 and the water 4 are decomposed by the cavitation generated within the ring 10 by using the ring 10 having a simple structure as above, and the carbon-based fuel 9 is able to be produced by composing the decomposed molecules 2a, 4a.

Since the carbon-based fuel 9 is produced by decomposing the molecules of the petroleum 2 and the water 4 by the cavitation, the molecules are decomposed in more reliable manner and with higher precision, for instance, in comparison with the case of hitting the petroleum 2 and the water 4 with a wave motion of which a frequency resonates with the liquid, i.e. the petroleum 2 and the water 4.

Consequently, the quality of the carbon-based fuel 9 becomes stable, the yield of the carbon-based fuel 9 becomes high, and the carbon-based fuel 9 is efficiently produced since the precision of decomposing the molecules is enhanced as mentioned above.

Since it is unnecessary to add the high temperature thermal energy or the high pressure in the process of decomposing the molecules of the petroleum 2 and the water 4 or composing the decomposed molecules of petroleum 2a and water 4a, large equipment and site for the high temperature and high pressure process are not required, thereby being able to produce the carbon-based fuel 9 by a simple method. Since the high temperature thermal energy is not required, inefficiency such as consuming the petroleum for producing the substitute for the petroleum is eliminated.

Production costs of synthesizing the fuels are remarkably reduced as compared with a prior art since the water 4 is used for the production of the carbon-based fuel 9. The amount of the carbon dioxide generated in the combustion of the carbon-based fuel 9 is reduced, which is a clue for solving the environmental problem such as global warming since the percentage of the hydrocarbon content in the carbon-based fuel 9 produced is less as compared with that in conventional fuel. Limited natural resource of petroleum is effectively utilized since the consumption amount of the petroleum is reduced by the amount of the water 4 content in the carbon-based fuel 9 as compared with the present situation.

A method for producing the carbon-based fuel in the second embodiment 1A is explained below.

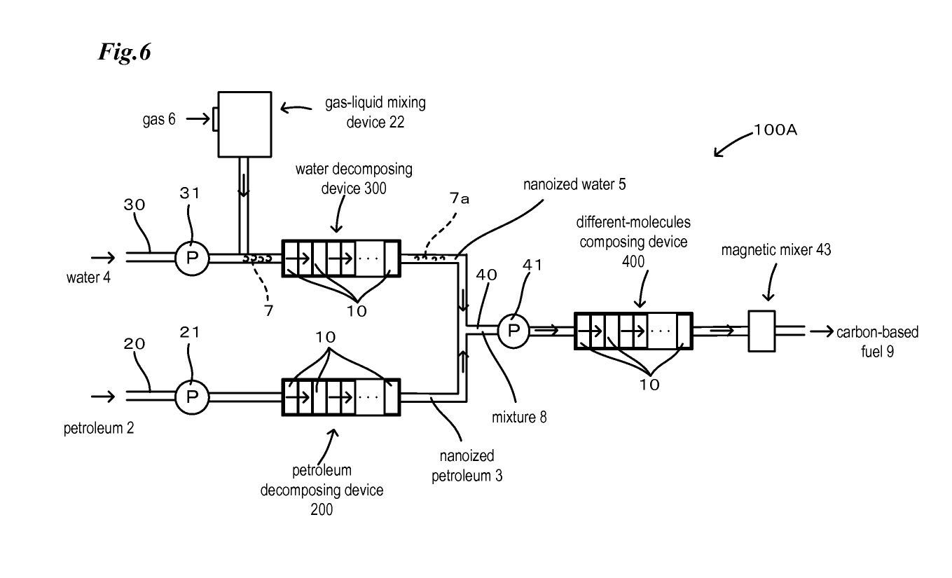

As shown in FIG. 1B, the method for producing the carbon-based fuel in the embodiment 1A is provided with a gas-liquid mixing step D which contains a lot of gas bubbles 7 in the water 4 before the water decomposing step B. As shown in FIG. 6, the method for producing carbon-based fuel 1A is performed by an apparatus for producing carbon-based fuel 100A provided with a device for gas-liquid mixing 22.

As shown in FIG. 6, in the gas-liquid mixing step D, a lot of gas bubbles 7 are contained in the water 4 by mixing gas 6 in the pipe 30 where the water 4 flows before the process in the first cavitation generation ring 10 (the first ring). The water 4 containing the gas bubbles 7 is caused to flow through the first ring 10 under high pressure, thereby generating the cavitation within the first ring 10. By the effect of the cavitation, the molecule of the water 4 is decomposed and the gas bubbles 7 are decomposed into nano size, thereby generating nano bubbles 7a.

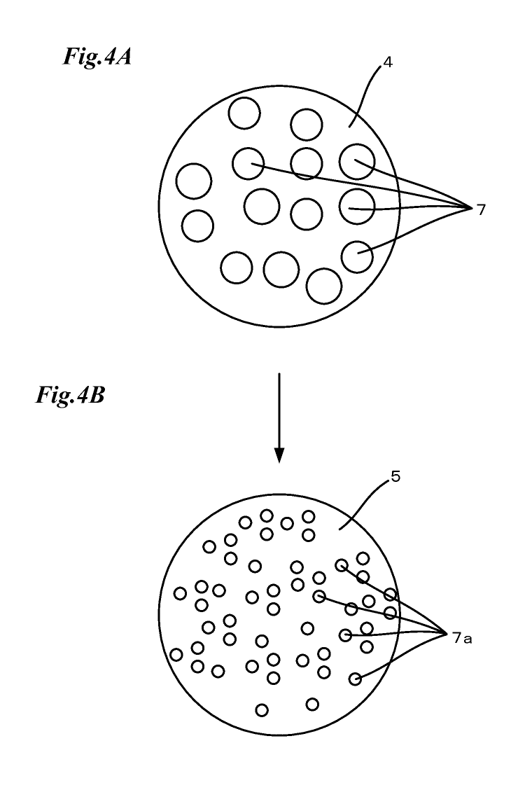

The gas bubbles 7 before being decomposed into nano size are shown in FIG. 4A and the nano bubbles 7a are shown in FIG. 4B. The size of the gas bubbles 7 is in a range from 200 micrometers to 2000 micrometers, and the size of the nano bubbles 7a is in a range from 100 nanometers to 500 nanometers.

The vacuum micro bubbles are generated in the water 4 by the cavitation generated within the first ring 10 and collide with the gas bubbles 7 generated in the water 4, thereby breaking (decomposing) the gas bubbles 7 into the nano bubbles 7a instantly.

Rapid adiabatic compression of reaction occurs in breaking as above and an extreme reaction field in ultrahigh pressure and ultrahigh temperature is formed in the nano bubbles 7a. The extreme reaction field affects the water 4 surrounding a periphery of the nano bubbles 7a, thereby decomposing the molecules of the water 4 effectively.

In the embodiment, as shown in FIG. 1B, the method for producing the carbon-based fuel 1A is further provided with a stabilizing step E which stabilizes molecule composing of a product generated by composing the decomposed molecules of petroleum 2a and water 4a decomposed in the different-molecules composing step C.

In the stabilizing step E, as shown in FIG. 6, the above-mentioned product is caused to flow through a magnetic mixer 43, and the molecule composing of the product is stabilized.

When the product is caused to flow through the magnetic mixer 43, a negative ion is imparted to the product. Thereby, the products become hardly stuck to each other by repulsion of the negative ions.

As for the magnetic mixer 43, various constitutions can be used as long as the negative ion is imparted to the product.

In the method for producing the carbon-based fuel in the second embodiment 1A constituted as above, the gas-liquid mixing step D where a lot of gas bubbles 7 are contained in the water 4 before the process in the water decomposing step B is provided.

Therefore, the molecule of water 4 surrounding a periphery of the nano bubbles 7a is effectively decomposed since the vacuum micro bubbles are generated in the water 4 by the cavitation and collide with the gas bubbles 7, and the gas bubbles 7 are instantly broken into the nano bubbles 7a, thereby generating the rapid adiabatic compression of a phenomenon.

In the embodiment, the method for producing the carbon-based fuel 1A is further provided with the stabilizing step E which stabilizes the molecule composing of the product generated by composing the decomposed molecules of petroleum 2a and water 4a.

Therefore, in the stabilizing step E, the negative ion is imparted to the product by allowing the product to flow through the magnetic mixer 43, thereby obtaining the products hardly stuck to each other and inhibiting the products from composing. The quality of the carbon-based fuel 9 becomes stable since the molecule composing of the product becomes stabilized.

Although the example provided with the gas-liquid mixing step D and the stabilizing step E is shown, the method for producing the carbon-based fuel in the second embodiment 1A can also be provided with either one of the above-mentioned steps D, E.

### REFERENCE SIGNS LIST

1,1A method for producing carbon-based fuel
A petroleum decomposing step
B water decomposing step
C different-molecules composing step
D gas-liquid mixing step
E stabilizing step
2 petroleum
2a decomposed molecule of petroleum
4 water
4a decomposed molecule of water
6 gas
7 gas bubble
8 mixture
9 carbon-based fuel
10,10A cavitation generation ring (from first to third cavitation generation ring, ring)
11 cylindrical portion
12,13,14,15 protruding portion
16 flow passage
20 pipe where petroleum flows
30 pipe where water flows
40 pipe where mixture flows
43 magnetic mixer
100,100A apparatus for producing carbon-based fuel
200 petroleum decomposing device
300 water decomposing device
400 different-molecules composing device

1. A cavitation generation ring configured to be housed in a part of a liquid communicating pipe,
wherein the cavitation generation ring has a plurality of protrusions protruding toward a center from an inner circumference of a cylindrical portion, the cylindrical portion constituting a liquid communication path of the liquid communication pipe, and
wherein liquid flows through the cavitation generation ring at high pressure and generates cavitation, thereby decomposing a molecule of the liquid.

2. An apparatus for producing carbon-based fuel, the apparatus comprising:
a petroleum decomposing device having the cavitation generation ring as set forth in claim 1 and being configured to decompose a molecule of petroleum;
a water decomposing device having the cavitation generation ring and being configured to decompose a molecule of water; and
a different-molecules composing device having the cavitation generation ring and being configured so that a mixture of the molecule of petroleum decomposed by the petroleum decomposing device and the molecule of water decomposed by the water decomposing device flows through the cavitation generation ring at high pressure, and generates cavitation, thereby carbon-based fuel is produced by composing the decomposed molecule of petroleum and the decomposed molecule of water.

3. A production method of carbon-based fuel, the production method comprising:
a petroleum decomposing step for decomposing a molecule of petroleum;
a water decomposing step for decomposing a molecule of water; and
a different-molecules composing step for composing the decomposed molecule of petroleum and the decomposed molecule of water,
wherein in the petroleum decomposing step, a first cavitation generation ring is housed in a part of a petroleum communication pipe and petroleum flows through the first cavitation generation ring at high pressure and generates cavitation, thereby decomposing the molecule of petroleum,
wherein in the water decomposing step, a second cavitation generation ring is housed in a part of a water communication pipe and water flows through the second cavitation generation ring at high pressure and generates cavitation, thereby decomposing the molecule of water,
wherein in the different-molecules composing step, a third cavitation generation ring is housed in a part of a pipe where the mixture of the decomposed molecule of water decomposed in the water decomposing step and the decomposed molecule of petroleum decomposed in the petroleum decomposing step flows, and the mixture flows through the third cavitation generation ring at high pressure and generates cavitation, thereby carbon-based fuel is produced by composing the decomposed molecule of petroleum and the decomposed molecule of water, and
wherein the first cavitation generation ring, the second cavitation generation ring and the third cavitation generation ring comprise the cavitation generation ring as set forth in claim 1.

4. The production method of carbon-based fuel as set forth in claim 3, the method comprising a step of mixing gas and liquid for containing a lot of gas bubbles in water by mixing gas in the water communicating pipe before the process in the first cavitation generation ring,
wherein the water containing gas bubbles flows at high pressure through the first cavitation generation ring and generates cavitation, thereby decomposing the molecule of water and decomposing the gas bubbles into nanosize.

5. The production method of carbon-based fuel as set forth in claim 3, wherein the different-molecules composing step further comprises a stabilizing step in which a product generated by composing the decomposed molecule of petroleum and the decomposed molecule of water flows through a magnetic mixer and molecule composition of the product is stabilized.

6. The production method of carbon-based fuel as set forth in claim 3, wherein the different-molecules composing step further comprises a stabilizing step in which a product generated by composing the decomposed molecule of petroleum and the decomposed molecule of water flows through a magnetic mixer and molecule composition of the product is stabilized.
